(19) United States
(12) Patent Application Publication
(10) Pub. No.: US 2025/0060561 A1
(43) Pub. Date: Feb. 20, 2025

(54) OPTICAL IMAGING SYSTEM

(71) Applicant: SAMSUNG ELECTRO-MECHANICS CO., LTD., Suwon-si (KR)

(72) Inventors: Byung Hyun KIM, Suwon-si (KR); Tae Yeon LIM, Suwon-si (KR)

(73) Assignee: SAMSUNG ELECTRO-MECHANICS CO., LTD., Suwon-si (KR)

(21) Appl. No.: 18/665,789

(22) Filed: May 16, 2024

(30) Foreign Application Priority Data
Aug. 14, 2023 (KR) 10-2023-0106386
Jan. 11, 2024 (KR) 10-2024-0004563

(51) Int. Cl. G02B 9/10

(52) U.S. Cl. CPC G02B 9/10

(57) ABSTRACT

An optical imaging system is provided. The optical imaging system includes a first lens group including a first lens, a reflective member, and a second lens arranged in order from an object side to an imaging side; and a second lens group disposed behind the second lens and including a plurality of lenses, wherein the first lens has positive refractive power, and has a convex object-side surface and a concave image-side surface, and the first lens is spaced apart from the reflective member, and the second lens is bonded to the reflective member.

### CROSS-REFERENCE TO RELATED APPLICATION(S)

This application claims the benefit under 35 USC § 119(a) to Korean Patent Application No. 10-2023-0106386 filed on Aug. 14, 2023, and Korean Patent Application No. 10-2024-0004563 filed on Jan. 11, 2024, in the Korean Intellectual Property Office, the entire disclosures of which are incorporated herein by reference for all purposes.

### BACKGROUND

### 1. Field

The following description relates to an optical imaging system.

### 2. Description of Related Art

Portable terminals may be equipped with a camera including an optical imaging system comprising a plurality of lenses to enable video calls and image capturing.

Additionally, with a gradual increase in the various operations of cameras disposed in portable terminals, the demand for cameras for portable terminals with high resolution has increased.

Furthermore, as the form factor of portable terminals has decreased, it is desirous that cameras for portable terminals have a slimmer form factor. Accordingly, the development of optical imaging systems that are slim, but are also capable of realizing high resolution, is desirous.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens group comprising a first lens, a reflective member, and a second lens arranged in order from an object side to an imaging side; and a second lens group, disposed behind the second lens, and comprising a plurality of lenses, wherein the first lens has positive refractive power, and has a convex object-side surface and a concave image-side surface, and wherein the first lens is spaced apart from the reflective member, and the second lens is bonded to the reflective member.

The reflective member may be configured to rotate based on two axes, perpendicular to each other.

One of the two axes may be one of an optical axis of the first lens or an axis, parallel to the optical axis of the first lens.

The reflective member may include an incident surface, a reflection surface, and an exit surface, and wherein an effective diameter of the object-side surface of the first lens may be greater than a minor axis length of the incident surface of the reflective member.

The reflective member may include an incident surface, a reflection surface, and an exit surface, and wherein 0.9<D11P/DP22<1.5 is satisfied, where D11P is a distance from the object-side surface of the first lens to the reflection surface of the reflective member, and DP22 is a distance from the reflection surface of the reflective member to an image-side surface of the second lens.

0.5<|RG1_S1/RG1_S2|<1.2 is satisfied, where RG1_S1 is a radius of curvature of the object-side surface of the first lens, and RG1_S2 is a radius of curvature of the image-side surface of the first lens.

1.7<n_p<2.0 is satisfied, where n_p is a refractive index of the reflective member.

−0.7<fG1/fG2<0 is satisfied, where fG1 is a total focal length of the first lens group, and fG2 is a total focal length of the second lens group.

0.4<f/f1<0.75 is satisfied, where f is a total focal length of the optical imaging system, and f1 is a focal length of the first lens.

0.1<f/f2<1.1 is satisfied, where f is a total focal length of the optical imaging system, and f2 is a focal length of the second lens.

−0.35<(RG1_S1−RG1_S2)/(RG1_S1+RG1_S2)<0 is satisfied, where RG1_S1 is a radius of curvature of the object-side surface of the first lens, and RG1_S2 is a radius of curvature of the image-side surface of the first lens.

The reflective member may include an incident surface, a reflection surface, and an exit surface, and 1<D11P/DR<1.3 is satisfied, where D11P is a distance from the object-side surface of the first lens to the reflection surface of the reflective member, and DR is the distance from the incident surface of the reflective member to the reflection surface of the reflective member.

0.4<D12P/DR<0.6 is satisfied, where D12P is a distance from the image-side surface of the first lens to the incident surface of the reflective member, and DR is a distance from the incident surface of the reflective member to the reflection surface of the reflective member.

The second lens may have positive refractive power and has a convex image-side surface.

At least three lenses of the lenses of the second lens group may have a refractive index greater than 1.6.

In a general aspect, an optical imaging system includes a reflective member; a first lens, having positive refractive power, and disposed in front of an incident surface of the reflective member; and a second lens, bonded to an exit surface of the reflective member, and configured to rotate with the reflective member, wherein the first lens is spaced apart from the reflective member.

The optical imaging system may include a total of seven lenses.

The first lens may have a convex object-side surface and a concave image-side surface.

The second lens may have a flat object-side surface.

Other features and aspects will be apparent from the following detailed description, the drawings, and the claims.

### BRIEF DESCRIPTION OF DRAWINGS

FIG. 1 illustrates an example optical imaging system, in accordance with a first example embodiment.

FIG. 2 illustrates aberration characteristics of the example optical imaging system illustrated in FIG. 1.

FIG. 3 illustrates an example optical imaging system, in accordance with a second example embodiment.

FIG. 4 illustrates aberration characteristics of the example optical imaging system illustrated in FIG. 3.

FIG. 5 illustrates an example optical imaging system, in accordance with a third example embodiment.

FIG. 6 illustrates aberration characteristics of the example optical imaging system illustrated in FIG. 5.

FIG. 7 illustrates an example optical imaging system, in accordance with a fourth example embodiment.

FIG. 8 illustrates aberration characteristics of the example optical imaging system illustrated in FIG. 7.

FIG. 9 illustrates an example optical imaging system, in accordance with a fifth example embodiment.

FIG. 10 illustrates aberration characteristics of the example optical imaging system illustrated in FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide an optical imaging system that is small in size, but also achieves high resolution.

One or more examples may reduce a size of the optical imaging system and capture high-resolution images.

In the following lens structural view, the thickness, size, and shape of the lens are somewhat exaggerated for explanation purposes, and in particular, a spherical or aspherical shape presented in the lens structural view is only presented as an example, and is not limited to this shape.

An optical imaging system, in accordance with one or more embodiments, may be mounted in a portable electronic device. In an example, the optical imaging system may be a configuration of a camera module mounted on a portable electronic device. In a non-limited example, the portable electronic device may be a portable electronic device such as a mobile communication terminal, a smartphone, or a tablet personal computer (PC), as only examples.

In the one or more examples, an object-side surface among surfaces of a lens denotes a surface close to (or facing) an object side, and an image-side surface denotes a surface close to (or facing) an image side. Additionally, in the one or more examples, numerical values for a radius of curvature, a thickness, a distance, and a focal length of a lens are all in mm, and the unit of a field of view (FOV) is in degrees.

Additionally, in the description of the shape of each lens, the disclosure that one surface is convex denotes that a paraxial region of the corresponding surface is convex, and the disclosure that one surface is concave denotes that the paraxial region of the corresponding surface is concave.

The paraxial region refers to a very narrow area of the lens near the optical axis.

The imaging surface may refer to a virtual surface on which a focus is formed by the optical imaging system. Alternatively, the imaging surface may refer to one surface of an image sensor on which light is received.

An optical imaging system, in accordance with one or more embodiments, includes a plurality of lens groups. As an example, the optical imaging system may include a first lens group and a second lens group.

Each of the first lens group and the second lens group includes a plurality of lenses. For example, each of the first lens group and the second lens group may include two or more lenses.

In an example embodiment, the optical imaging system includes a first lens, a second lens, a third lens, a fourth lens, a fifth lens, a sixth lens, and a seventh lens arranged in order from an object side to an imaging side. In this example, the first lens group may include a first lens and a second lens, and the second lens group may include the third to seventh lenses.

The optical imaging system, in accordance with one or more embodiments, may further include a reflective member having a reflection surface that changes an optical path. In an example embodiment, the reflection surface of the reflective member may be configured to change the optical path by 90°. The reflective member may be a mirror or a prism.

In an example embodiment, the reflective member may be disposed between the first lens and the second lens.

When the reflective member is a prism, the reflective member may have a shape in which a rectangular parallelepiped or a cube is bisected in a diagonal direction. A prism includes an incident surface through which light is incident, a reflection surface through which light passing through the incident surface is reflected, and an exit surface through which light reflected from the reflection surface is emitted.

Light passing through the first lens may pass through the incident surface of the reflective member, and a light path thereof may be changed by 90° on the reflection surface, and the light may pass through the exit surface of the reflective member and enter the second lens.

Since the reflective member may be disposed between the first lens and the second lens, an optical axis of the first lens and an optical axis of the second to seventh lenses may be perpendicular to each other.

In an example, an optical axis direction of the first lens may be substantially parallel to a thickness direction of a portable terminal, and an optical axis direction of the second to seventh lenses may be substantially parallel to a longitudinal or width direction of the portable terminal.

The reflective member includes three square-shaped surfaces and two triangular-shaped surfaces. For example, each of the incident surface, the reflection surface, and the exit surface of the reflective member is square-shaped, and both side surfaces of the reflective member are approximately triangular-shaped.

By bending the optical path through the reflective member, a long optical path may be formed in a relatively narrow space.

Accordingly, the optical imaging system may be miniaturized and may have a long focal length.

The optical imaging system, in accordance with one or more embodiments, has characteristics of a telephoto lens having a relatively narrow field of view (FOV) and a long focal length.

Additionally, the optical imaging system may further include an image sensor that converts an image of an incident subject into an electrical signal.

Additionally, the optical imaging system may further include an infrared blocking filter (hereinafter referred to as a filter) to block infrared rays. A filter may be disposed between the seventh lens and the image sensor.

In an example embodiment, the first lens group may include a first lens, a reflective member, and a second lens, and the second lens group may include a third lens, a fourth lens, a fifth lens, a sixth lens, and a seventh lens. However, this is only an example, and the first lens group and the second lens group may include a varied arrangement of lens.

In an example embodiment, a plurality of lenses may be spaced apart from each other in an optical axis direction.

In an example embodiment, some lenses among the plurality of lenses may be configured as bonded lenses. In an example, an object-side surface of the second lens may be bonded to an exit surface of the reflective member.

An effective radius of the first lens may be larger than effective radii of the other lenses. That is, in an example, among the first to seventh lenses, an effective radius of the first lens may be the largest.

In an example, the first lens may have a different shape from the shape of the other lenses. For example, when viewed from an optical axis direction of the first lens, the first lens may have a substantially circular shape. Furthermore, the second to seventh lenses may have a non-circular shape. In a non-limited example, the first lens may have a circular planar shape, and the second to seventh lenses may have a non-circular planar shape.

In a plane perpendicular to an optical axis, for the non-circular lens, a length in a first axis direction perpendicular to the optical axis may be longer than a length in a second axis direction perpendicular to both the optical axis and the first axis direction. For the non-circular lens, a ratio of the length in the second axis direction to the length in the first axis direction may be greater than 0.5 and less than 1.

In an example, the non-circular lens has a shape in which a portion of a circle is cut off when viewed from the optical axis direction.

In an example, the first axis direction is a direction in which a long side of the image sensor extends, and the second axis direction is a direction in which a short side of the image sensor extends.

For the non-circular lens, the length in the first axis direction may be longer than the length in the second axis direction, and thus, the non-circular lens may have a major axis effective radius and a minor axis effective radius.

The first lens group has positive refractive power as a whole, and the first lens group includes at least one lens having a meniscus shape convex toward an object side.

In an example embodiment, the first lens group includes two lenses (e.g., a first lens and a second lens). The first lens is disposed closer to an object-side, in front of the reflective member (e.g., in front of an incident surface of the reflective member), and the second lens is disposed closer to an image-side, in the rear of the reflective member (e.g., behind an exit surface of the reflective member).

The first lens may have positive refractive power and may have a meniscus shape that is convex toward the object side. A radius of curvature of an object-side surface of the first lens may be smaller than a radius of curvature of an image-side surface of the first lens.

An effective diameter of the object-side surface of the first lens may be larger than a minor axis length of an incident surface of the reflective member.

The first lens may be formed of plastic, and each of the object-side surface and the image-side surface of the first lens may be aspherical.

The second lens may have positive refractive power and may have a convex image-side surface. The second lens may be formed of glass.

The second lens group includes a plurality of lenses and has negative refractive power as a whole.

Among a plurality of lenses in the second lens group, at least three lenses have a refractive index greater than 1.6.

Among the plurality of lenses in the second lens group, a lens disposed closest to the reflective member has positive refractive power.

In an example embodiment, the second lens group includes a third lens, a fourth lens, a fifth lens, a sixth lens, and a seventh lens. The third lens has positive refractive power, the fourth lens has negative refractive power, the fifth lens has positive refractive power, the sixth lens has positive refractive power, and the seventh lens may have positive or negative refractive power.

The third to seventh lenses may be configured to have a refractive index and an Abbe number different from adjacent lenses.

In an example, the reflective member is disposed in front of the second lens group. The reflective member may be rotated based on two axes, perpendicular to each other, to compensate for shaking during an image-capturing operation.

That is, when shaking occurs due to factors such as the user's hand tremoring during the capturing of an image or the shooting of a video, the shaking may be compensated for by rotating the reflective member in response to the shaking.

In an example embodiment, the reflective member may be rotated using an optical axis (or an axis parallel to the optical axis) of the first lens as a rotation axis. Additionally, the reflective member may be rotated using a major axis (or an axis parallel to the major axis) of a reflection surface of the reflective member as the rotation axis. The major axis of the reflection surface of the reflective member may intersect an optical axis of the first lens. Additionally, the major axis of the reflection surface of the reflective member may intersect an optical axis of the second lens group. For example, the reflective member may be rotated using an axis perpendicular to both the optical axis of the first lens and the optical axis of the second lens group (or an axis parallel to the axis) as a rotation axis.

Since the reflective member may have a relatively lighter weight than the optical imaging system, shaking may be easily compensated with smaller driving force.

Since the first lens having positive refractive power is disposed in front of the reflective member, the light incident on the reflective member may be converged, and thus a diameter of the second lens group may be formed to be small. Accordingly, a height of the optical imaging system may be reduced while reducing the Fno (f-number) of the optical imaging system.

Additionally, in an example, the first lens may be rotated together with the reflective member. In this example, when the reflective member is rotated using the optical axis of the first lens (or an axis parallel to the optical axis) as the rotation axis, an error may occur in an optical path passing through the first lens, resulting in a decrease in resolution. However, in an example embodiment, an error in the optical path that occurs during shake correction may be compensated for by disposing a second lens having positive refractive power behind the reflective member. In an example, the second lens may be rotated together with the reflective member.

In an example embodiment, for some of the lenses included in the first lens group, an object-side surface and an image-side surface may be spherical.

In an example embodiment, for one or more lenses among a plurality of lenses included in the second lens group, an object-side surface and an image-side surface may be aspherical.

In an example embodiment, some of the first to seventh lenses may be formed of a different material from other lenses. For example, the second lens may be formed of glass, and the remaining lenses except the second lens may be formed of plastic.

An aspherical surface of the lens is expressed by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} \qquad Equation 1$$

In Equation 1, c represents a curvature of a lens surface (inverse number of the radius of curvature), K represents a Conic constant, and Y represents a distance from any point on an aspherical surface of the lens to an optical axis. Additionally, constants A to J refer to an aspheric coefficient. Furthermore, Z (SAG) represents a distance in an optical axis direction from any point on the aspherical surface of the lens to a vertex of the aspherical surface.

An optical imaging system, in accordance with one or more embodiments, may satisfy at least one of the conditional expressions below.

In an example embodiment, the optical imaging system may satisfy the condition 0.9<D11P/DP22<1.5. In an example, D11P is a distance from an object-side surface of the first lens to a reflection surface of the reflective member, and DP22 is a distance from the reflection surface of the reflective member to an image side surface of the second lens. Accordingly, the optical imaging system may be miniaturized.

In an example embodiment, the optical imaging system may satisfy the condition 0.5<|RG1_S1/RG1_S2|<1.2. In an example, RG1_S1 is a radius of curvature of an object-side surface of a primary lens (e.g., a first lens) of the first lens group, and RG1_S2 is a radius of curvature of an image-side surface of the primary lens (e.g., the first lens) of the first lens group. Accordingly, during shake correction, an error in the optical path passing through the first lens may be minimized, and resolution reduction due to shake correction may be prevented.

In an example embodiment, the optical imaging system may satisfy the condition 1.7<n_p<2.0. In an example, n_p is a refractive index of the reflective member. Accordingly, light in the reflective member may be completely reflected. Additionally, driving load may be reduced during shake compensation.

In an example embodiment, the optical imaging system may satisfy the condition 0.4<f/f1<0.75. In an example, f is a total focal length of the optical imaging system, and f1 is a focal length of the first lens. Accordingly, image brightness may be secured by appropriately adjusting refractive power of the first lens.

In an example embodiment, the optical imaging system may satisfy the condition 0.1<f/f2<1.1. In an example, f2 is a focal length of the second lens. Accordingly, it may be possible to prevent resolution reduction due to shake correction by appropriately adjusting the refractive power of the second lens.

In an example embodiment, the optical imaging system may satisfy the condition −0.7<fG1/fG2<0. In an example, fG1 is a focal length of the first lens group, and fG2 is a focal length of the second lens group. Accordingly, by appropriately distributing refractive power of each lens group, the optical imaging system may be miniaturized and resolution may be improved.

In an example embodiment, the optical imaging system may satisfy the condition −0.35<(RG1_S1−RG1_S2)/(RG1_S1+RG1_S2)<0. In an example, RG1_S1 is a radius of curvature of an object-side surface of the first lens, and RG1_S2 is a radius of curvature of an image-side surface of the first lens. Accordingly, spherical aberration occurring in the first lens may be minimized. Additionally, by appropriately adjusting the focal length of the first lens, an occurrence of aberration may be minimized while maintaining sufficient telephoto performance.

In an example embodiment, the optical imaging system may satisfy the condition 1<D11P/DR<1.3. In an example, DR is a distance from an incident surface of the reflective member to a reflection surface of the reflective member (or a distance from the reflection surface to the exit surface). Accordingly, it may be possible to prevent the optical imaging system from becoming significantly thick in an optical axis direction of the first lens.

In an example embodiment, the optical imaging system may satisfy the condition 0.4<D12P/DR<0.6. In an example, D12P is a distance from the image-side surface of the first lens to the incident surface of the reflective member. Accordingly, the first lens and the reflective member may be prevented from interfering with each other, and the optical imaging system may be miniaturized.

In an example embodiment, the optical imaging system may satisfy the condition −0.8<f/fG2<0. Accordingly, by appropriately distributing refractive power of each lens group, the optical imaging system may be miniaturized and resolution may be improved.

In an example embodiment, the optical imaging system may satisfy the condition 1.5<DP22/DR<2.5. Accordingly, a driving load during shake correction may be minimized and the optical imaging system may be miniaturized.

In an example embodiment, the optical imaging system may satisfy the condition −0.3<RG2_S1/fG2<0. In an example, RG2_S1 is a radius of curvature of an object-side surface of a primary lens (e.g., a third lens) of the second lens group. Accordingly, by optimizing refractive power of the second lens group, spherical aberration may be reduced and resolution may be improved.

In an example embodiment, the optical imaging system may satisfy the condition 0.4<fG1/L<0.8. In an example, L is a sum of a distance from the object-side surface of the first lens to the reflection surface of the reflective member and a distance from the reflection surface of the reflective member to an imaging surface. Accordingly, the optical imaging system may be miniaturized and an occurrence of aberration may be minimized.

In an example embodiment, the optical imaging system may satisfy the condition 0.1<Lf/Lr<0.3. In an example, Lf is a distance from the object-side surface of the first lens to the reflection surface of the reflective member, and Lr is a distance from the reflection surface of the reflective member to the imaging surface. Accordingly, the optical imaging system may be miniaturized.

In an example embodiment, the optical imaging system may satisfy the condition 0<D12P/L<0.07. Accordingly, the optical imaging system may be miniaturized by appropriately adjusting a distance between the first lens and the reflective member.

In an example embodiment, the optical imaging system may satisfy the condition 0<D23/L<0.15. In an example, D23 is a distance from an image-side surface of a last lens (e.g., a second lens) of the first lens group to an object-side surface of the primary lens (e.g., the third lens) of the second lens group. Accordingly, the optical imaging system may be miniaturized by appropriately adjusting a distance between the reflective member and the second lens group.

In an example embodiment, the optical imaging system may satisfy the condition 0.3<D3/L<0.6. In an example, D3 is a distance from the object-side surface of the primary lens (e.g., the third lens) of the second lens group to an image-side surface of a last lens (e.g., a seventh lens) of the second lens group. Accordingly, aberration may be minimized and the optical imaging system may be miniaturized.

In an example embodiment, the optical imaging system may satisfy the condition 2.5<Fno×(fG1/f)<5. In an example, Fno is an F-number of the optical imaging system. Accordingly, image brightness and resolution may be improved.

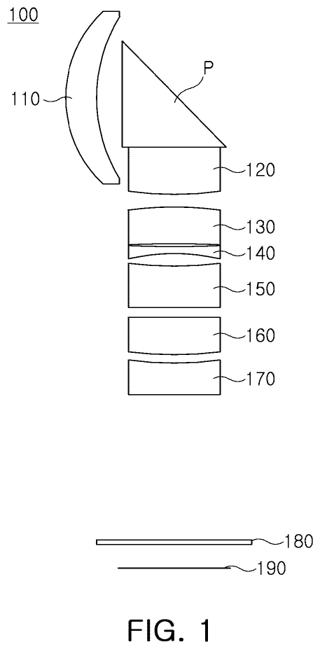

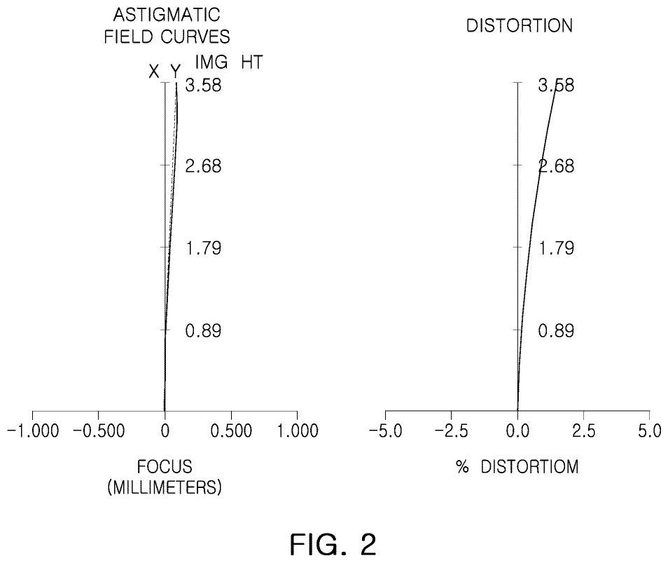

FIG. 1 illustrates an example optical imaging system according to a first embodiment, and FIG. 2 illustrates aberration characteristics of the example optical imaging system illustrated in FIG. 1.

An optical imaging system according to a first example embodiment will be described with reference to FIGS. 1 and 2.

The optical imaging system according to the first embodiment includes a first lens group and a second lens group. Additionally, the optical imaging system includes a reflective member P disposed in front of (or on an object-side of) the second lens group.

In order from an object side to the imaging side, the first lens group includes a first lens 110 and a second lens 120, and the second lens group includes a third lens 130, a fourth lens 140, and a fifth lens 150, a sixth lens 160, and a seventh lens 170.

The first lens group may further include a reflective member P disposed on (or adjacent to) the first lens 110 and the second lens 120.

In a non-limited example, the first lens 110, and the third lens 130 to the seventh lens 170 may be formed of plastic, and the second lens 120 may be formed of glass.

Additionally, the optical imaging system may further include a filter 180 and an image sensor.

The optical imaging system according to the first embodiment may form a focus on an imaging surface 190. The imaging surface 190 may refer to a surface on which a focus is formed by an optical imaging system. As an example, the imaging surface 190 may refer to one surface of the image sensor on which light is received.

In the first embodiment, the reflective member P may be a prism. However, this is only an example, and the reflective member P may also be provided as a mirror.

The characteristics of each lens (a radius of curvature, a thickness of the lens or a distance between lenses, an index of refraction, and an Abbe number) are shown in Table 1 below.

In an example, due to the coordinate system code convention of an optical design program, the signs of the radius of curvature, the thickness, or the distance are reversed from a reflection surface of the prism, but the signs are not changed in the tables below for convenience.

TABLE 1

| | | | | | | Major Axis | Minor Axis | |
|---|---|---|---|---|---|---|---|---|
| Surface | | | Thickness or | | Abbe | Effective | Effective | Focal |
| Number | Division | Radius | Distance | Index | Number | Radius | Radius | Length |
| S1 | First lens | 5.828 | 1.200 | 1.535 | 55.71 | 3.8 | | 40.8269 |
| S2 | | 7.367 | 1.000 | | | 3.531 | | |
| S3 | Prism | Infinity | 2.100 | 1.923 | 20.88 | | | |
| S4 | | Infinity | 2.100 | 1.923 | 20.88 | | | |
| S5 | | Infinity | 0.000 | | | | | |
| S6 | Second lens | Infinity | 2.000 | 1.497 | 81.61 | 3.569 | 1.8 | 22.3829 |
| S7 | | −11.157 | 0.500 | | | 3.389 | 1.8 | |
| S8 | Third lens | 4.710 | 1.563 | 1.535 | 55.71 | 2.295 | 1.67 | 13.8651 |
| S9 | | 11.328 | 0.111 | | | 1.974 | 1.67 | |
| S10 | Fourth lens | 43.365 | 0.278 | 1.614 | 25.93 | 1.973 | 1.67 | −7.9069 |
| S11 | | 4.394 | 0.512 | | | 1.818 | 1.67 | |
| S12 | Fifth lens | −38.255 | 1.851 | 1.544 | 55.97 | 1.811 | 1.67 | 74.6415 |
| S13 | | −20.076 | 0.442 | | | 2.064 | 1.67 | |
| S14 | Sixth lens | −16.042 | 1.500 | 1.661 | 20.37 | 2.122 | 1.67 | 11.5439 |
| S15 | | −5.405 | 0.414 | | | 2.216 | 1.67 | |
| S16 | Seventh lens | −11.781 | 1.334 | 1.639 | 23.48 | 2.121 | 1.67 | −11.6283 |
| S17 | | 21.609 | 6.133 | | | 2.384 | 1.67 | |
| S18 | Filter | Infinity | 0.210 | 1.517 | 64.20 | | | |
| S19 | | Infinity | 1.000 | | | | | |
| S20 | Imaging | Infinity | −0.005 | | | | | |
| | Surface | | | | | | | |

In an example, a total focal length f of the optical imaging system according to the first embodiment is 18.61 mm, Fno is 3.4, and IMG HT is 3.575 mm.

In the first embodiment, the first lens group has positive refractive power as a whole, and the second lens group has negative refractive power as a whole.

An effective radius of an object-side surface of the first lens 110 of the first lens group is larger than an effective radius of an image-side surface thereof.

A focal length fG1 of the first lens group is 16.387 mm, and a focal length fG2 of the second lens group is −45.602 mm.

A major axis length of an incident surface of the reflective member P is 7.2 mm, and a minor axis length thereof is 4.2 mm.

The first lens 110 has positive refractive power, an object-side surface of the first lens 110 is convex, and an image-side surface of the first lens 110 is concave.

The second lens 120 has positive refractive power, an object-side surface of the second lens 120 is flat, and an image-side surface of the second lens 120 is convex.

The third lens 130 has positive refractive power, an object-side surface of the third lens 130 is convex, and an image-side surface of the third lens 130 is concave.

The fourth lens 140 has negative refractive power, an object-side surface of the fourth lens 140 is convex, and an image-side surface of the fourth lens 140 is concave.

The fifth lens 150 has positive refractive power, an object-side surface of the fifth lens 150 is concave, and an image-side surface of the fifth lens 150 is convex.

The sixth lens 160 has positive refractive power, an object-side surface of the sixth lens 160 is concave, and an image-side surface of the sixth lens 160 is convex.

The seventh lens 170 has negative refractive power, and an object-side surface and an image-side surface of the seventh lens 170 are concave.

Additionally, the second lens 120 may be bonded to the reflective member P. In an example, an exit surface of the reflective member P and the object-side surface of the second lens 120 may be bonded to each other.

In an example, each surface of the first lens 110, and the third lens 130 to the seventh lens 170 has an aspheric coefficient as shown in Table 2. For example, the object-side surface and the image-side surface of each of the first lens 110, and the third lens 130 to the seventh lens 170 are aspherical surfaces.

TABLE 2

| | S1 | S2 | S8 | S9 | S10 | S11 |
|---|---|---|---|---|---|---|
| Conic | −0.013 | −0.019 | 0.169 | 0.000 | 0.000 | −0.950 |
| Constant(K) | | | | | | |
| Fourth | 5.999E−05 | 2.174E−04 | 1.318E−03 | −3.304E−03 | 3.898E−04 | 2.258E−03 |
| Coefficient(A) | | | | | | |
| Sixth | 7.143E−06 | 1.492E−05 | −4.859E−05 | 7.419E−04 | −9.598E−05 | −3.814E−04 |
| Coefficient(B) | | | | | | |
| Eighth | 8.942E−08 | 3.774E−07 | 1.889E−04 | 2.117E−05 | −3.812E−05 | −2.362E−04 |
| Coefficient(C) | | | | | | |
| Tenth | −3.365E−09 | −1.777E−08 | −6.731E−05 | 2.977E−05 | −5.541E−06 | 7.545E−06 |
| Coefficient(D) | | | | | | |
| Twelfth | 3.068E−12 | −9.063E−10 | 1.690E−05 | −4.365E−06 | 2.509E−06 | 1.270E−05 |
| Coefficient(E) | | | | | | |
| Fourteenth | 9.611E−11 | 3.277E−10 | −2.367E−06 | 5.978E−07 | 4.615E−08 | −8.165E−06 |
| Coefficient(F) | | | | | | |
| Sixteenth | 2.904E−12 | 7.173E−12 | 1.970E−07 | −3.069E−08 | 2.219E−09 | 1.498E−06 |
| Coefficient(G) | | | | | | |
| Eighteenth | −4.267E−14 | −6.274E−13 | −1.038E−08 | 9.039E−11 | 1.361E−09 | −1.170E−07 |
| Coefficient(H) | | | | | | |
| Twentieth | −2.556E−14 | −7.453E−14 | 3.796E−10 | −4.790E−10 | −4.337E−10 | 5.931E−09 |
| Coefficient(J) | | | | | | |

| | S12 | S13 | S14 | S15 | S16 | S17 |
|---|---|---|---|---|---|---|
| Conic | 0.000 | 74.361 | −97.155 | −1.685 | 11.682 | 69.973 |
| Constant(K) | | | | | | |
| Fourth | 2.987E−04 | −1.754E−03 | −4.555E−03 | −4.718E−03 | 3.526E−03 | 6.406E−03 |
| Coefficient(A) | | | | | | |
| Sixth | −7.210E−05 | 9.589E−05 | −5.304E−04 | −2.078E−04 | 1.584E−03 | 5.465E−04 |
| Coefficient(B) | | | | | | |
| Eighth | −5.735E−05 | 3.823E−05 | 4.327E−04 | 7.269E−04 | −2.594E−04 | −2.450E−04 |
| Coefficient(C) | | | | | | |
| Tenth | −9.417E−07 | 9.298E−06 | −8.290E−05 | −2.145E−04 | 1.534E−04 | 7.852E−05 |
| Coefficient(D) | | | | | | |
| Twelfth | 1.743E−07 | −7.004E−07 | 8.451E−06 | 3.623E−05 | −5.960E−05 | −2.039E−05 |
| Coefficient(E) | | | | | | |
| Fourteenth | 1.182E−07 | −1.895E−07 | −3.817E−07 | −3.530E−06 | 1.268E−05 | 3.483E−06 |
| Coefficient(F) | | | | | | |
| Sixteenth | −1.214E−08 | −6.690E−09 | 3.591E−08 | 2.118E−07 | −1.458E−06 | −3.334E−07 |
| Coefficient(G) | | | | | | |
| Eighteenth | −2.609E−09 | 1.142E−09 | −1.179E−09 | −7.792E−09 | 8.968E−08 | 1.810E−08 |
| Coefficient(H) | | | | | | |
| Twentieth | −1.761E−09 | 2.238E−11 | −4.334E−10 | 2.979E−11 | −2.009E−09 | −3.950E−10 |
| Coefficient(J) | | | | | | |

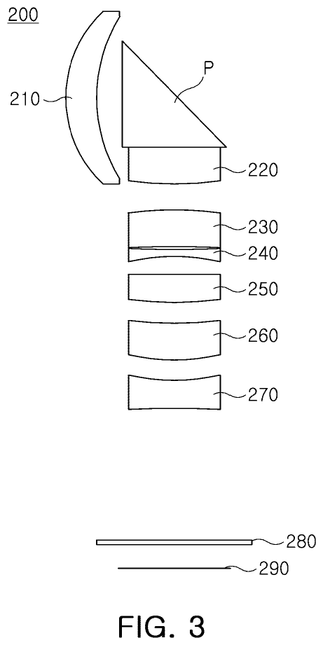

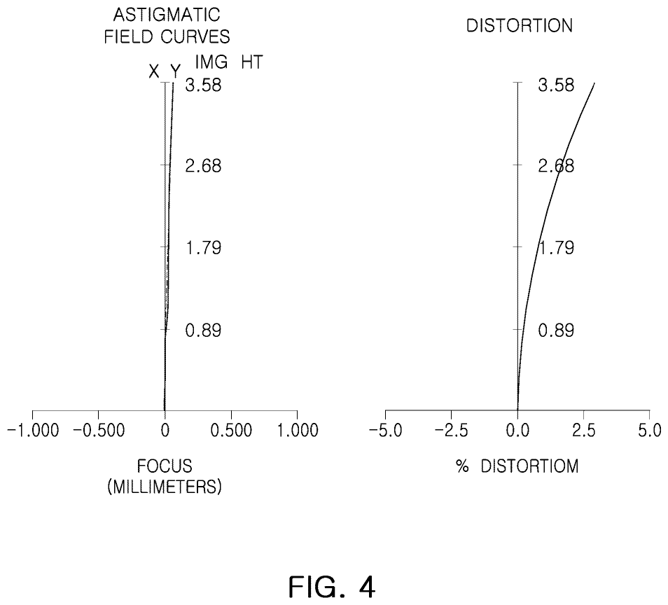

FIG. 3 illustrates an example optical imaging system according to a second example embodiment, and FIG. 4 illustrates aberration characteristics of the example optical imaging system illustrated in FIG. 3.

An optical imaging system according to a second example embodiment will be described with reference to FIGS. 3 and 4.

An optical imaging system according to a second embodiment includes a first lens group and a second lens group. Additionally, the optical imaging system includes a reflective member P disposed in front of the second lens group.

In order from an object side to an imaging side, the first lens group includes a first lens 210 and a second lens 220, and the second lens group includes a third lens 230, a fourth lens 240, and a fifth lens 250, a sixth lens 260, and a seventh lens 270.

The first lens group may further include a reflective member P disposed on (or adjacent to) the first lens 210 and the second lens 220.

In an example, the first lens 210, and the third lens 230 to the seventh lens 270 may be formed of plastic, and the second lens 220 may be formed of glass.

Additionally, the optical imaging system may further include a filter 280 and an image sensor.

The optical imaging system according to the second embodiment may form a focus on an imaging surface 290. The imaging surface 290 may refer to a surface on which a focus is formed by the optical imaging system. As an example, the imaging surface 290 may refer to one surface of the image sensor on which light is received.

In the second embodiment, the reflective member P may be a prism. However, this is only an example, and the reflective member P may also be provided as a mirror.

The characteristics of each lens (a radius of curvature, a thickness of the lens or a distance between lenses, an index of refraction, and an Abbe number) are shown in Table 3 below.

TABLE 3

| | | | | | | Major Axis | Minor Axis | |
|---|---|---|---|---|---|---|---|---|
| Surface | | | Thickness or | | Abbe | Effective | Effective | Focal |
| Number | Division | Radius | Distance | Index | Number | Radius | Radius | Length |
| S1 | First lens | 5.950 | 1.225 | 1.535 | 55.71 | 3.7 | | 41.6825 |
| S2 | | 7.521 | 1.021 | | | 3.447 | | |
| S3 | Prism | Infinity | 2.150 | 1.923 | 20.88 | | | |
| S4 | | Infinity | 2.150 | 1.923 | 20.88 | | | |
| S5 | | infinity | 0.000 | | | | | |
| S6 | Second | Infinity | 1.500 | 1.497 | 81.61 | 3.643 | 1.85 | 23.5559 |
| | lens | | | | | | | |
| S7 | | −11.741 | 1.046 | | | 3.460 | 1.85 | |
| S8 | Third lens | 4.590 | 1.415 | 1.535 | 55.71 | 2.343 | 1.7 | 13.3965 |
| S9 | | 11.310 | 0.126 | | | 2.073 | 1.7 | |
| S10 | Fourth lens | 56.008 | 0.309 | 1.614 | 25.93 | 2.071 | 1.7 | −7.3516 |
| S11 | | 4.206 | 1.070 | | | 1.876 | 1.7 | |
| S12 | Fifth lens | −73.220 | 1.000 | 1.544 | 55.97 | 1.849 | 1.7 | 54.5892 |
| S13 | | −21.294 | 1.244 | | | 1.986 | 1.7 | |
| S14 | Sixth lens | −16.314 | 1.500 | 1.661 | 20.37 | 2.172 | 1.7 | 10.9006 |
| S15 | | −5.222 | 0.614 | | | 2.290 | 1.7 | |
| S16 | Seventh | −10.878 | 1.000 | 1.639 | 23.48 | 2.188 | 1.7 | −11.3636 |
| | lens | | | | | | | |
| S17 | | 23.342 | 5.494 | | | 2.434 | 1.7 | |
| S18 | Filter | Infinity | 0.210 | 1.517 | 64.20 | | | |
| S19 | | Infinity | 1.000 | | | | | |
| S20 | Imaging | Infinity | −0.005 | | | | | |
| | Surface | | | | | | | |

a total focal length f of the optical imaging system according to the second embodiment is 19 mm, Fno is 3.3, and IMG HT is 3.575 mm.

In the second embodiment, the first lens group has positive refractive power as a whole, and the second lens group has negative refractive power as a whole.

An effective radius of an object-side surface of the first lens 210 of the first lens group is larger than an effective radius of an image-side surface of the first lens 210 of the first lens group f.

A focal length fG1 of the first lens group is 16.931 mm, and a focal length fG2 of the second lens group is −50.617 mm.

A major axis length of an incident surface of the reflective member P is 7.5 mm, and a minor axis length thereof is 4.3 mm.

The first lens 210 has positive refractive power, an object-side surface of the first lens 210 is convex, and an image-side surface of the first lens 210 is concave.

The second lens 220 has positive refractive power, an object-side surface of the second lens 220 is flat, and an image-side surface of the second lens 220 is convex.

The third lens 230 has positive refractive power, an object-side surface of the third lens 230 is convex, and an image-side surface of the third lens 230 is concave.

The fourth lens 240 has negative refractive power, an object-side surface of the fourth lens 240 is convex, and an image-side surface of the fourth lens 240 is concave.

The fifth lens 250 has positive refractive power, an object-side surface of the fifth lens 250 is concave, and an image-side surface of the fifth lens 250 is convex.

The sixth lens 260 has positive refractive power, an object-side surface of the sixth lens 260 is concave, and an image-side surface of the sixth lens 260 is convex.

The seventh lens 270 has negative refractive power, and an object-side surface and an image-side surface of the seventh lens 270 are concave.

Additionally, the second lens 220 may be bonded to the reflective member P. For example, an exit surface of the reflective member P and the object-side surface of the second lens 220 may be bonded to each other.

In an example, each surface of the first lens 210, and the third lens 230 to the seventh lens 270 has an aspherical coefficient as shown in Table 4. For example, the object-side surface and the image-side surface of each of the first lens 210, and the third lens 230 to the seventh lens 270 are aspherical surfaces.

TABLE 4

| | S1 | S2 | S8 | S9 | S10 | S11 |
|---|---|---|---|---|---|---|
| Conic | −0.019 | −0.011 | 0.164 | 0.000 | 0.000 | −0.962 |
| Constant(K) | | | | | | |
| Fourth | 5.474E−05 | 2.116E−04 | 1.255E−03 | −3.011E−03 | 3.398E−04 | 2.140E−03 |
| Coefficient(A) | | | | | | |
| Sixth | 5.694E−06 | 1.251E−05 | −4.622E−05 | 6.700E−04 | −6.635E−05 | −3.930E−04 |
| Coefficient(B) | | | | | | |
| Eighth | −1.500E−08 | 1.904E−07 | 1.624E−04 | 1.675E−05 | −2.581E−05 | −2.215E−04 |
| Coefficient(C) | | | | | | |
| Tenth | −9.766E−09 | −2.743E−08 | −5.600E−05 | 2.469E−05 | −3.363E−06 | 3.411E−06 |
| Coefficient(D) | | | | | | |
| Twelfth | −4.133E−10 | −1.743E−09 | 1.344E−05 | −3.300E−06 | 2.109E−06 | 9.904E−06 |
| Coefficient(E) | | | | | | |
| Fourteenth | 5.148E−11 | 1.806E−10 | −1.807E−06 | 5.323E−07 | 3.050E−08 | −6.158E−06 |
| Coefficient(F) | | | | | | |
| Sixteenth | 1.005E−12 | 1.464E−12 | 1.451E−07 | −4.257E−09 | −2.269E−09 | 1.117E−06 |
| Coefficient(G) | | | | | | |
| Eighteenth | −9.445E−14 | −5.450E−13 | −7.050E−09 | 3.162E−09 | 4.932E−10 | −8.300E−08 |
| Coefficient(H) | | | | | | |
| Twentieth | −2.172E−14 | −5.285E−14 | 3.139E−10 | −3.301E−10 | 3.047E−10 | −3.178E−09 |
| Coefficient(J) | | | | | | |

| | S12 | S13 | S14 | S15 | S16 | S17 |
|---|---|---|---|---|---|---|
| Conic | 0.000 | 73.008 | −89.060 | −1.694 | 11.098 | 69.377 |
| Constant(K) | | | | | | |
| Fourth | 2.704E−04 | −1.737E−03 | −4.274E−03 | −4.441E−03 | 3.224E−03 | 6.136E−03 |
| Coefficient(A) | | | | | | |
| Sixth | −3.209E−05 | 7.653E−05 | −4.839E−04 | −1.854E−04 | 1.411E−03 | 4.769E−04 |
| Coefficient(B) | | | | | | |
| Eighth | −4.299E−05 | 3.310E−05 | 3.748E−04 | 6.279E−04 | −2.320E−04 | −2.120E−04 |
| Coefficient(C) | | | | | | |
| Tenth | −2.617E−07 | 8.094E−06 | −6.845E−05 | −1.783E−04 | 1.257E−04 | 6.512E−05 |
| Coefficient(D) | | | | | | |
| Twelfth | −6.178E−08 | −4.210E−07 | 6.820E−06 | 2.876E−05 | −4.765E−05 | −1.627E−05 |
| Coefficient(E) | | | | | | |
| Fourteenth | −1.059E−08 | −1.126E−07 | −2.826E−07 | −2.710E−06 | 9.657E−06 | 2.647E−06 |
| Coefficient(F) | | | | | | |
| Sixteenth | −3.276E−08 | −2.296E−09 | 2.883E−08 | 1.531E−07 | −1.074E−06 | −2.462E−07 |
| Coefficient(G) | | | | | | |
| Eighteenth | −8.607E−09 | 8.442E−10 | −9.117E−10 | −5.699E−09 | 6.177E−08 | 1.245E−08 |
| Coefficient(H) | | | | | | |
| Twentieth | 1.802E−09 | 2.328E−10 | −4.419E−10 | −1.557E−12 | −1.801E−09 | −2.771E−10 |
| Coefficient(J) | | | | | | |

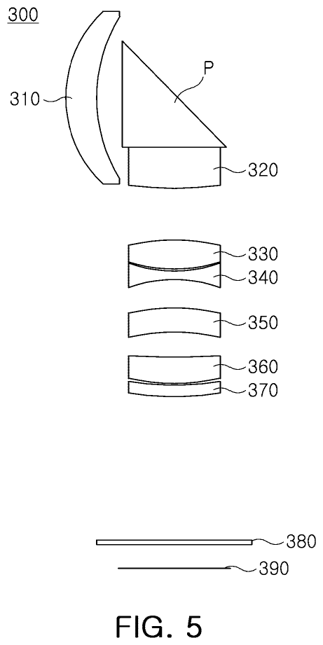

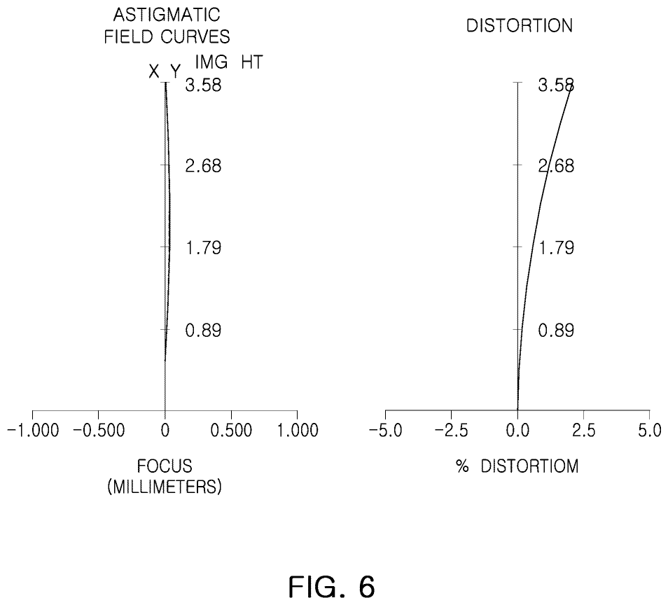

FIG. 5 illustrates an optical imaging system according to a third example embodiment, and FIG. 6 illustrates aberration characteristics of the optical imaging system illustrated in FIG. 5.

An optical imaging system according to a third example embodiment will be described with reference to FIGS. 5 and 6.

The optical imaging system according to the third embodiment includes a first lens group and a second lens group. Additionally, the optical imaging system includes a reflective member P disposed in front of the second lens group.

In order from an object side to an imaging side, the first lens group includes a first lens 310 and a second lens 320, and the second lens group includes a third lens 330, a fourth lens 340, a fifth lens 350, a sixth lens 360, and a seventh lens 370.

The first lens group may further include a reflective member P disposed on (or adjacent to) the first lens 310 and the second lens 320.

The first lens 310, and the third lens 330 to the seventh lens 370 may be formed of plastic, and the second lens 320 may be formed of glass.

Additionally, the optical imaging system may further include a filter 380 and an image sensor.

The optical imaging system according to the third embodiment may form a focus on an imaging surface 390. The imaging surface 390 may refer to a surface on which a focus is formed by the optical imaging system. As an example, the imaging surface 390 may refer to one surface of the image sensor on which light is received.

In the third embodiment, the reflective member P may be a prism. However, this is only an example, and the reflective member P may also be provided as a mirror.

The characteristics of each lens (a radius of curvature, a thickness of the lens or a distance between lenses, an index of refraction, and an Abbe number) are shown in Table 5 below.

TABLE 5

| | | | | | | Major Axis | Minor Axis | |
|---|---|---|---|---|---|---|---|---|
| Surface | | | Thickness or | | Abbe | Effective | Effective | Focal |
| Number | Division | Radius | Distance | Index | Number | Radius | Radius | Length |
| S1 | First lens | 6.328 | 1.290 | 1.535 | 55.71 | 3.5 | | 27.3660 |
| S2 | | 10.322 | 1.075 | | | 3.068 | | |
| S3 | Prism | Infinity | 2.100 | 1.785 | 25.72 | | | |
| S4 | | Infinity | 2.100 | 1.785 | 25.72 | | | |
| S5 | | Infinity | 0.000 | | | | | |
| S6 | Second | Infinity | 1.579 | 1.785 | 25.72 | 3.835 | 1.8 | 23.1518 |
| | lens | | | | | | | |
| S7 | | −18.334 | 2.375 | | | 3.642 | 1.8 | |
| S8 | Third lens | 4.169 | 0.736 | 1.535 | 55.71 | 1.861 | 1.67 | 6.1208 |
| S9 | | −14.597 | 0.110 | | | 1.747 | 1.67 | |
| S10 | Fourth lens | −7.033 | 0.481 | 1.639 | 23.48 | 1.772 | 1.67 | −2.9927 |
| S11 | | 2.735 | 0.822 | | | 1.640 | 1.67 | |
| S12 | Fifth lens | 5.226 | 1.000 | 1.535 | 55.71 | 1.946 | 1.67 | 134.1369 |
| S13 | | 5.257 | 0.844 | | | 1.905 | 1.67 | |
| S14 | Sixth lens | −14.154 | 1.239 | 1.661 | 20.37 | 2.060 | 1.67 | 10.3283 |
| S15 | | −4.803 | 0.100 | | | 2.286 | 1.67 | |
| S16 | Seventh | −8.854 | 0.560 | 1.639 | 23.48 | 2.307 | 1.67 | 4535.268 |
| | lens | | | | | | | |
| S17 | | −9.047 | 7.383 | | | 2.303 | 1.67 | |
| S18 | Filter | Infinity | 0.210 | 1.517 | 64.20 | | | |
| S19 | | Infinity | 1.000 | | | | | |
| S20 | Imaging | Infinity | −0.005 | | | | | |
| | Surface | | | | | | | |

In an example, a total focal length f of the optical imaging system according to the third embodiment is 19.9815 mm, Fno is 3.5, and IMG HT is 3.575 mm.

In the third embodiment, the first lens group has positive refractive power as a whole, and the second lens group has negative refractive power as a whole.

An effective radius of an object-side surface of the first lens 310 of the first lens group is larger than an effective radius of an image-side surface thereof.

A focal length fG1 of the first lens group is 14.311 mm, and a focal length fG2 of the second lens group is −104.724 mm.

A major axis length of an incident surface of the reflective member P is 7.0 mm, and a minor axis length is 4.2 mm.

The first lens 310 has positive refractive power, an object-side surface of the first lens 310 is convex, and an image-side surface of the first lens 310 is concave.

The second lens 320 has positive refractive power, an object-side surface of the second lens 320 is flat, and an image-side surface of the second lens 320 is convex.

The third lens 330 has positive refractive power, and an object-side surface and an image-side surface of the third lens 330 are convex.

The fourth lens 340 has negative refractive power, and an object-side surface and an image-side surface of the fourth lens 340 are concave.

The fifth lens 350 has positive refractive power, an object-side surface of the fifth lens 350 is convex, and an image-side surface of the fifth lens 350 is concave.

The sixth lens 360 has positive refractive power, an object-side surface of the sixth lens 360 is concave, and an image-side surface of the sixth lens 360 is convex.

The seventh lens 370 has positive refractive power, an object-side surface of the seventh lens 370 is concave, and an image-side surface of the seventh lens 370 is convex.

Additionally, the second lens 320 may be bonded to the reflective member P. For example, an exit surface of the reflective member P and the object-side surface of the second lens 320 may be bonded to each other.

In an example 2, each surface of the first lens 310, and the third lens 330 to the seventh lens 370 has an aspherical coefficient as shown in Table 6. For example, the object-side surface and the image-side surface of each of the first lens 310, and the third lens 330 and the seventh lens 370 are aspherical surfaces.

TABLE 6

| | S1 | S2 | S8 | S9 | S10 | S11 |
|---|---|---|---|---|---|---|
| Conic | 0.037 | 0.205 | 0.185 | 0.000 | 0.000 | −0.870 |
| Constant(K) | | | | | | |
| Fourth | 1.338E−04 | 3.893E−04 | 1.977E−03 | −2.155E−03 | 5.389E−04 | 3.157E−03 |
| Coefficient(A) | | | | | | |
| Sixth | 1.299E−05 | 1.621E−05 | 6.589E−05 | 5.886E−04 | −7.713E−05 | −4.161E−04 |
| Coefficient(B) | | | | | | |
| Eighth | −3.109E−07 | 3.885E−07 | 1.257E−04 | −2.556E−05 | −9.715E−05 | −1.810E−04 |
| Coefficient(C) | | | | | | |
| Tenth | 4.063E−08 | −3.545E−09 | −4.806E−05 | −3.507E−05 | −5.726E−06 | 1.347E−05 |
| Coefficient(D) | | | | | | |
| Twelfth | −1.853E−10 | −1.282E−09 | 6.339E−06 | −8.761E−07 | 2.177E−06 | 5.826E−06 |
| Coefficient(E) | | | | | | |
| Fourteenth | −1.287E−10 | −2.433E−10 | −1.281E−06 | 1.100E−06 | −1.297E−07 | −3.828E−06 |
| Coefficient(F) | | | | | | |
| Sixteenth | −1.513E−11 | −7.508E−11 | 1.012E−07 | 3.614E−07 | −2.800E−07 | −1.865E−07 |
| Coefficient(G) | | | | | | |
| Eighteenth | −1.228E−12 | 2.846E−12 | 1.254E−07 | 1.688E−07 | −2.319E−07 | −4.036E−08 |
| Coefficient(H) | | | | | | |
| Twentieth | 1.589E−13 | 2.986E−13 | 1.159E−07 | −3.595E−10 | 9.979E−10 | −1.199E−09 |
| Coefficient(J) | | | | | | |

| | S12 | S13 | S14 | S15 | S16 | S17 |
|---|---|---|---|---|---|---|
| Conic | 0.000 | 0.000 | 0.000 | −1.422 | −1.041 | 0.000 |
| Constant(K) | | | | | | |
| Fourth | −4.129E−04 | −1.291E−03 | −4.615E−03 | −3.410E−03 | 2.040E−03 | 5.099E−03 |
| Coefficient(A) | | | | | | |
| Sixth | −1.396E−04 | 1.141E−04 | −4.138E−04 | −1.684E−04 | 1.068E−03 | 3.053E−04 |
| Coefficient(B) | | | | | | |
| Eighth | −2.605E−05 | 1.506E−05 | 2.752E−04 | 4.410E−04 | −1.729E−04 | −1.447E−04 |
| Coefficient(C) | | | | | | |
| Tenth | 1.860E−06 | 4.868E−06 | −4.175E−05 | −1.123E−04 | 7.670E−05 | 4.240E−05 |
| Coefficient(D) | | | | | | |
| Twelfth | −2.015E−07 | −1.947E−07 | 4.205E−06 | 1.622E−05 | −2.715E−05 | −9.199E−06 |
| Coefficient(E) | | | | | | |
| Fourteenth | 2.666E−08 | −3.160E−08 | −1.375E−07 | −1.352E−06 | 4.964E−06 | 1.292E−06 |
| Coefficient(F) | | | | | | |
| Sixteenth | −1.419E−08 | −6.881E−10 | 1.367E−08 | 7.090E−08 | −4.964E−07 | −1.138E−07 |
| Coefficient(G) | | | | | | |
| Eighteenth | −3.103E−09 | 1.674E−09 | −9.648E−10 | −2.307E−09 | 2.611E−08 | 5.154E−09 |
| Coefficient(H) | | | | | | |
| Twentieth | 1.133E−09 | −2.023E−12 | −2.689E−10 | 3.174E−11 | −6.723E−10 | −1.091E−10 |
| Coefficient(J) | | | | | | |

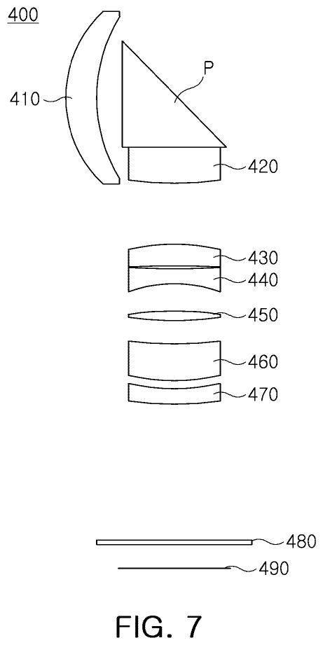

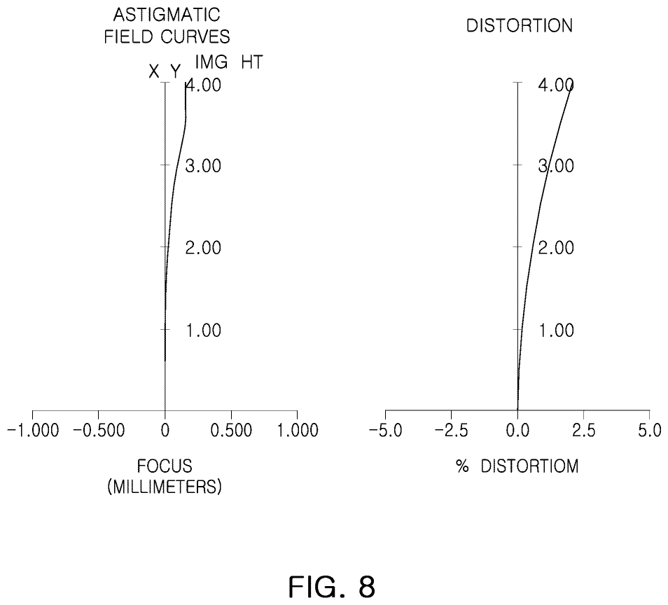

FIG. 7 illustrates an optical imaging system according to a fourth example embodiment, and FIG. 8 illustrates aberration characteristics of the optical imaging system illustrated in FIG. 7.

An optical imaging system according to a fourth example embodiment will be described with reference to FIGS. 7 and 8.

The optical imaging system according to the fourth embodiment includes a first lens group and a second lens group. Additionally, the optical imaging system includes a reflective member P disposed in front of the second lens group.

In order from an object side to an imaging side, the first lens group includes a first lens 410 and a second lens 420, and the second lens group includes a third lens 430, a fourth lens 440, a fifth lens 450, a sixth lens 460, and a seventh lens 470.

The first lens group may further include a reflective member P disposed on (or adjacent to) the first lens 410 and the second lens 420.

In an example, the first lens 410, and the third lens 430 to the seventh lens 470 may be formed of plastic, and the second lens 420 may be formed of glass.

Additionally, the optical imaging system may further include a filter 480 and an image sensor.

The optical imaging system according to the fourth embodiment may form a focus on an imaging surface 490. The imaging surface 490 may refer to a surface on which a focus is formed by the optical imaging system. In an example, the imaging surface 490 may refer to one surface of the image sensor on which light is received.

In the fourth embodiment, the reflective member P may be a prism. However, this is only an example, and the reflective member P may also be provided as a mirror.

The characteristics of each lens (a radius of curvature, a thickness of the lens or a distance between lenses, an index of refraction, and an Abbe number) are shown in Table 7 below.

TABLE 7

| | | | | | | Major Axis | Minor Axis | |
|---|---|---|---|---|---|---|---|---|
| Surface | | | Thickness or | | Abbe | Effective | Effective | Focal |
| Number | Division | Radius | Distance | Index | Number | Radius | Radius | Length |
| S1 | First lens | 6.059 | 1.248 | 1.535 | 55.71 | 3.8 | | 42.4438 |
| S2 | | 7.659 | 1.040 | | | 3.533 | | |
| S3 | Prism | Infinity | 2.194 | 1.785 | 25.72 | | | |
| S4 | | Infinity | 2.194 | 1.785 | 25.72 | | | |
| S5 | | Infinity | 0.000 | | | | | |
| S6 | Second | Infinity | 1.527 | 1.517 | 64.17 | 3.710 | 1.9 | 24.7041 |
| | lens | | | | | | | |
| S7 | | −12.815 | 2.382 | | | 3.523 | 1.9 | |
| S8 | Third lens | 4.050 | 0.822 | 1.535 | 55.71 | 2.386 | 1.8 | 9.5299 |
| S9 | | 18.027 | 0.200 | | | 2.108 | 1.8 | |
| S10 | Fourth lens | −24.591 | 0.400 | 1.614 | 25.93 | 2.106 | 1.8 | −5.0141 |
| S11 | | 3.581 | 1.218 | | | 1.864 | 1.8 | |
| S12 | Fifth lens | 38.339 | 0.373 | 1.544 | 55.97 | 1.883 | 1.8 | 34.4260 |
| S13 | | −36.793 | 0.741 | | | 1.932 | 1.8 | |
| S14 | Sixth lens | −12.154 | 1.417 | 1.661 | 20.37 | 2.086 | 1.8 | 8.7168 |
| S15 | | −4.122 | 0.429 | | | 2.279 | 1.8 | |
| S16 | Seventh | −9.376 | 0.400 | 1.639 | 23.48 | 2.244 | 1.8 | −12.7437 |
| | lens | | | | | | | |
| S17 | | 68.217 | 7.407 | | | 2.478 | 1.8 | |
| S18 | Filter | Infinity | 0.210 | 1.517 | 64.20 | | | |
| S19 | | Infinity | 1.000 | | | | | |
| S20 | Imaging | Infinity | −0.005 | | | | | |
| | Surface | | | | | | | |

In an example, a total focal length f of the optical imaging system according to the fourth embodiment is 19.4 mm, Fno is 3.3, and IMG HT is 4 mm.

In the fourth embodiment, the first lens group has positive refractive power as a whole, and the second lens group has negative refractive power as a whole.

An effective radius of an object-side surface of the first lens 410 of the first lens group is larger than an effective radius of an image-side surface thereof.

A focal length fG1 of the first lens group is 17.593 mm, and a focal length fG2 of the second lens group is −256.883 mm.

A major axis length of an incident surface of the reflective member P is 7.6 mm, and a minor axis length is 4.4 mm.

The first lens 410 has positive refractive power, an object-side surface of the first lens 410 is convex, and an image-side surface of the first lens 410 is concave.

The second lens 420 has positive refractive power, an object-side surface of the second lens 420 is flat, and an image-side surface of the second lens 420 is convex.

The third lens 430 has positive refractive power, an object-side surface of the third lens 430 is convex, and an image-side surface of the third lens 430 is concave.

The fourth lens 440 has negative refractive power, and an object-side surface and an image-side surface of the fourth lens 440 are concave.

The fifth lens 450 has positive refractive power, and an object-side surface and an image-side surface of the fifth lens 450 are convex.

The sixth lens 460 has positive refractive power, an object-side surface of the sixth lens 460 is concave, and an image-side surface of the sixth lens 460 is convex.

The seventh lens 470 has negative refractive power, and an object-side surface and an image-side surface of the seventh lens 470 are concave.

Additionally, the second lens 420 may be bonded to the reflective member P. For example, an exit surface of the reflective member P and the object-side surface of the second lens 420 may be bonded to each other.

In an example, each surface of the first lens 410, and the third lens 430 to the seventh lens 470 has an aspherical coefficient as shown in Table 8 below. For example, the object-side surface and the image-side surface of the first lens 410, and the third lens 430 to the seventh lens 470 are aspherical surfaces.

TABLE 8

| | S1 | S2 | S8 | S9 | S10 | S11 |
|---|---|---|---|---|---|---|
| Conic | −0.055 | 0.216 | 0.144 | 0.000 | 0.000 | −0.961 |
| Constant(K) | | | | | | |
| Fourth | 1.576E−05 | 3.097E−04 | 1.235E−03 | −2.701E−03 | 3.820E−04 | 2.067E−03 |
| Coefficient(A) | | | | | | |
| Sixth | 4.193E−06 | 1.144E−05 | −3.043E−06 | 5.781E−04 | 1.250E−05 | −4.364E−04 |
| Coefficient(B) | | | | | | |
| Eighth | −2.033E−07 | −1.606E−08 | 1.492E−04 | 5.556E−06 | −7.262E−06 | −2.054E−04 |
| Coefficient(C) | | | | | | |
| Tenth | −2.393E−08 | −4.085E−08 | −4.736E−05 | 1.880E−05 | −7.304E−08 | 8.513E−06 |
| Coefficient(D) | | | | | | |
| Twelfth | −1.144E−09 | −2.629E−09 | 1.115E−05 | −2.904E−06 | 1.859E−06 | 7.254E−06 |
| Coefficient(E) | | | | | | |
| Fourteenth | 1.229E−11 | 8.282E−11 | −1.439E−06 | 4.761E−07 | −9.588E−08 | −5.020E−06 |
| Coefficient(F) | | | | | | |
| Sixteenth | 7.956E−13 | −1.967E−12 | 1.199E−07 | 3.251E−08 | −1.590E−08 | 8.254E−07 |
| Coefficient(G) | | | | | | |
| Eighteenth | −4.220E−14 | −2.338E−13 | −2.581E−09 | 1.113E−08 | −7.029E−10 | −7.097E−08 |
| Coefficient(H) | | | | | | |
| Twentieth | −9.107E−15 | −1.204E−14 | 9.342E−10 | −6.754E−10 | 1.875E−09 | −2.254E−09 |
| Coefficient(J) | | | | | | |

| | S12 | S13 | S14 | S15 | S16 | S17 |
|---|---|---|---|---|---|---|
| Conic | 0.000 | 73.904 | 0.000 | −1.216 | 9.883 | −33.937 |
| Constant(K) | | | | | | |
| Fourth | 1.600E−04 | −1.631E−03 | −4.439E−03 | −3.878E−03 | 2.011E−03 | 6.955E−03 |
| Coefficient(A) | | | | | | |
| Sixth | −9.765E−05 | 1.238E−04 | −4.310E−04 | −1.935E−04 | 1.269E−03 | 4.264E−04 |
| Coefficient(B) | | | | | | |
| Eighth | −4.850E−05 | 4.219E−05 | 3.330E−04 | 5.529E−04 | −2.019E−04 | −1.946E−04 |
| Coefficient(C) | | | | | | |
| Tenth | −1.629E−06 | 1.014E−05 | −5.804E−05 | −1.505E−04 | 1.068E−04 | 5.508E−05 |
| Coefficient(D) | | | | | | |
| Twelfth | −9.476E−07 | 1.789E−07 | 5.732E−06 | 2.354E−05 | −3.899E−05 | −1.340E−05 |
| Coefficient(E) | | | | | | |
| Fourteenth | −3.606E−09 | 3.443E−08 | −1.623E−07 | −2.148E−06 | 7.645E−06 | 2.091E−06 |
| Coefficient(F) | | | | | | |
| Sixteenth | −2.364E−08 | 8.172E−10 | 3.591E−08 | 1.169E−07 | −8.184E−07 | −1.875E−07 |
| Coefficient(G) | | | | | | |
| Eighteenth | −5.455E−09 | 6.378E−10 | 1.724E−09 | −4.327E−09 | 4.464E−08 | 9.171E−09 |
| Coefficient(H) | | | | | | |
| Twentieth | 2.129E−09 | −3.800E−12 | −1.190E−10 | 4.576E−11 | −1.254E−09 | −1.215E−10 |
| Coefficient(J) | | | | | | |

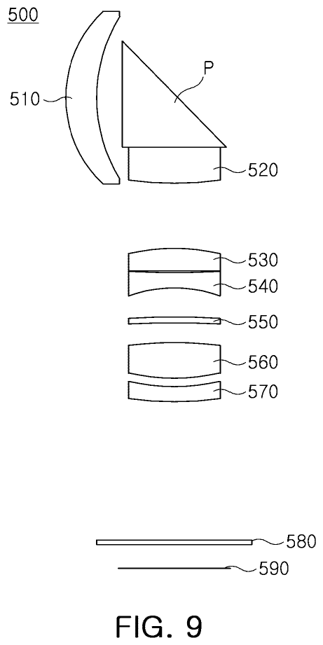

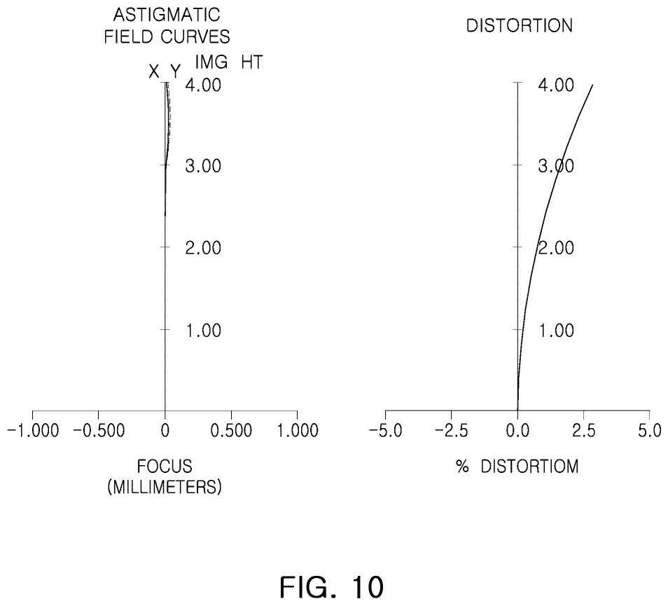

FIG. 9 illustrates an optical imaging system according to a fifth example embodiment, and FIG. 10 illustrates aberration characteristics of the optical imaging system illustrated in FIG. 9.

An optical imaging system according to a fifth example embodiment will be described with reference to FIGS. 9 and 10.

The optical imaging system according to the fifth embodiment includes a first lens group and a second lens group. Additionally, the optical imaging system includes a reflective member P disposed in front of the second lens group.

In order from the object side to the imaging side, the first lens group includes the first lens 510 and the second lens 520, and the second lens group includes a third lens 530, a fourth lens 540, a fifth lens 550, a sixth lens 560, and a seventh lens 570.

The first lens group may further include a reflective member P disposed on, (or adjacent to), the first lens 510 and the second lens 520.

In an example, the first lens 510, and the third lens 530 to the seventh lens 570 may be formed of plastic, and the second lens 520 may be formed of glass.

Additionally, the optical imaging system may further include a filter 580 and an image sensor.

The optical imaging system according to the fifth embodiment may form a focus on an imaging surface 590. The imaging surface 590 may refer to a surface on which a focus is formed by the optical imaging system. As an example, the imaging surface 590 may refer to one surface of the image sensor on which light is received.

In the fifth embodiment, the reflective member P may be a prism. However, this is only an example, and the reflective member P may also be provided as a mirror.

The characteristics of each lens (a radius of curvature, a thickness of the lens or a distance between lenses, an index of refraction, and an Abbe number) are shown in Table 9 below.

TABLE 9

| | | | | | | Major Axis | Minor Axis | |
|---|---|---|---|---|---|---|---|---|
| Surface | | | Thickness or | | Abbe | Effective | Effective | Focal |
| Number | Division | Radius | Distance | Index | Number | Radius | Radius | Length |
| S1 | First lens | 6.059 | 1.248 | 1.535 | 55.71 | 3.8 | | 42.4438 |
| S2 | | 7.659 | 1.040 | | | 3.529 | | |
| S3 | Prism | Infinity | 2.200 | 1.785 | 25.72 | | | |
| S4 | | Infinity | 2.200 | 1.785 | 25.72 | | | |
| S5 | | Infinity | 0.000 | | | | | |
| S6 | Second | Infinity | 1.527 | 1.517 | 64.17 | 3.710 | 1.9 | 18.6775 |
| | lens | | | | | | | |
| S7 | | −9.688 | 2.273 | | | 3.523 | 1.9 | |
| S8 | Third lens | 4.508 | 0.829 | 1.535 | 55.71 | 2.386 | 1.8 | 7.6784 |
| S9 | | −45.405 | 0.131 | | | 2.080 | 1.8 | |
| S10 | Fourth lens | −11.436 | 0.517 | 1.614 | 25.93 | 2.078 | 1.8 | −3.9930 |
| S11 | | 3.215 | 1.157 | | | 1.817 | 1.8 | |
| S12 | Fifth lens | 12.813 | 0.277 | 1.544 | 55.97 | 1.883 | 1.8 | 819.1454 |
| S13 | | 13.090 | 0.799 | | | 1.920 | 1.8 | |
| S14 | Sixth lens | 11.487 | 1.477 | 1.661 | 20.37 | 2.175 | 1.8 | 6.3053 |
| S15 | | −6.313 | 0.413 | | | 2.280 | 1.8 | |
| S16 | Seventh | −9.468 | 0.400 | 1.639 | 23.48 | 2.207 | 1.8 | −8.6925 |
| | lens | | | | | | | |
| S17 | | 14.004 | 6.217 | | | 2.478 | 1.8 | |
| S18 | Filter | Infinity | 0.210 | 1.517 | 64.20 | | | |
| S19 | | Infinity | 1.000 | | | | | |
| S20 | Imaging | Infinity | −0.005 | | | | | |
| | Surface | | | | | | | |

In an example, a total focal length f of the optical imaging system according to the fifth embodiment is 19.4 mm, Fno is 3.3, and IMG HT is 4 mm.

In the fifth embodiment, the first lens group has positive refractive power as a whole, and the second lens group has negative refractive power as a whole.

An effective radius of an object-side surface of the first lens 510 of the first lens group is larger than an effective radius of the image side surface thereof.

A focal length fG1 of the first lens group is 14.8 mm, and a focal length fG2 of the second lens group is −30 mm.

A major axis length of an incident surface of the reflective member P is 7.5 mm, and a minor axis length is 4.4 mm.

The first lens 510 has positive refractive power, an object-side surface of the first lens 510 is convex, and an image-side surface of the first lens 510 is concave.

The second lens 520 has positive refractive power, an object-side surface of the second lens 520 is flat, and an image-side surface of the second lens 520 is convex.

The third lens 530 has positive refractive power, and an object-side surface and an image-side surface of the third lens 530 are convex.

The fourth lens 540 has negative refractive power, and an object-side surface and an image-side surface of the fourth lens 540 are concave.

The fifth lens 550 has positive refractive power, an object-side surface of the fifth lens 550 is convex, and an image-side surface of the fifth lens 550 is concave.

The sixth lens 560 has positive refractive power, and an object-side surface and an image-side surface of the sixth lens 560 are convex.

The seventh lens 570 has negative refractive power, and an object-side surface and an image-side surface of the seventh lens 570 are concave.

Additionally, the second lens 520 may be bonded to the reflective member P. For example, an exit surface of the reflective member P and the object-side surface of the second lens 520 may be bonded to each other.

In an example, each surface of the first lens 510, and the third lens 530 to the seventh lens 570 has an aspherical coefficient as shown in Table 10 below. For example, the object-side surface and the image-side surface of each of the first lens 510, and the third lens 530 to the seventh lens 570 are aspherical surfaces.

TABLE 10

| | S1 | S2 | S8 | S9 | S10 | S11 |
|---|---|---|---|---|---|---|
| Conic | −0.055 | 0.216 | 0.067 | 0.000 | 0.000 | −0.991 |
| Constant(K) | | | | | | |
| Fourth | 1.576E−05 | 3.097E−04 | 1.486E−03 | −2.449E−03 | 1.894E−04 | 2.191E−03 |
| Coefficient(A) | | | | | | |
| Sixth | 4.193E−06 | 1.144E−05 | −7.604E−05 | 6.089E−04 | 1.032E−06 | −5.179E−04 |
| Coefficient(B) | | | | | | |
| Eighth | −2.033E−07 | −1.606E−08 | 1.400E−04 | −1.588E−06 | −3.586E−06 | −2.437E−04 |
| Coefficient(C) | | | | | | |
| Tenth | −2.393E−08 | −4.085E−08 | −4.741E−05 | 1.609E−05 | −4.610E−07 | 1.796E−05 |
| Coefficient(D) | | | | | | |
| Twelfth | −1.144E−09 | −2.629E−09 | 1.134E−05 | −3.548E−06 | 1.426E−06 | 7.254E−06 |
| Coefficient(E) | | | | | | |
| Fourteenth | 1.229E−11 | 8.282E−11 | −1.395E−06 | 2.968E−07 | −2.286E−07 | −5.020E−06 |
| Coefficient(F) | | | | | | |
| Sixteenth | 7.956E−13 | −1.967E−12 | 1.199E−07 | 3.251E−08 | −1.590E−08 | 8.254E−07 |
| Coefficient(G) | | | | | | |
| Eighteenth | −4.220E−14 | −2.338E−13 | −2.581E−09 | 1.113E−08 | −7.029E−10 | −7.097E−08 |
| Coefficient(H) | | | | | | |
| Twentieth | −9.107E−15 | −1.204E−14 | 9.342E−10 | −6.754E−10 | 1.875E−09 | −2.254E−09 |
| Coefficient(J) | | | | | | |

| | S12 | S13 | S14 | S15 | S16 | S17 |
|---|---|---|---|---|---|---|
| Conic | 0.000 | −34.394 | 0.000 | −1.500 | 9.641 | 36.531 |
| Constant(K) | | | | | | |
| Fourth | 2.152E−04 | −1.744E−03 | −4.338E−03 | −3.968E−03 | 2.064E−03 | 6.576E−03 |
| Coefficient(A) | | | | | | |
| Sixth | −1.532E−04 | 2.315E−04 | −5.209E−04 | −1.432E−04 | 1.232E−03 | 3.413E−04 |
| Coefficient(B) | | | | | | |
| Eighth | −4.465E−05 | 5.189E−05 | 3.236E−04 | 5.621E−04 | −2.147E−04 | −2.029E−04 |
| Coefficient(C) | | | | | | |
| Tenth | −4.882E−07 | 9.433E−06 | −5.783E−05 | −1.495E−04 | 1.032E−04 | 5.490E−05 |
| Coefficient(D) | | | | | | |
| Twelfth | −1.126E−06 | 2.400E−07 | 6.131E−06 | 2.371E−05 | −3.975E−05 | −1.316E−05 |
| Coefficient(E) | | | | | | |
| Fourteenth | −3.606E−09 | 1.587E−07 | −7.748E−08 | −2.116E−06 | 7.446E−06 | 2.169E−06 |
| Coefficient(F) | | | | | | |
| Sixteenth | −2.364E−08 | 8.172E−10 | 4.872E−08 | 1.205E−07 | −8.468E−07 | −1.725E−07 |
| Coefficient(G) | | | | | | |
| Eighteenth | −5.455E−09 | 6.378E−10 | 3.557E−09 | −2.594E−09 | 4.215E−08 | 1.249E−08 |
| Coefficient(H) | | | | | | |
| Twentieth | 2.129E−09 | −3.800E−12 | 2.721E−10 | −6.859E−11 | −1.254E−09 | −3.352E−11 |
| Coefficient(J) | | | | | | |

TABLE 11

| Conditional | First | Second | Third | Fourth | Fifth |
|---|---|---|---|---|---|
| Expression | Embodiment | Embodiment | Embodiment | Embodiment | Embodiment |
| D11P/DP22 | 1.049 | 1.204 | 1.213 | 1.204 | 1.204 |
| \|RG1_S1/RG1_S2\| | 0.791 | 0.791 | 0.613 | 0.791 | 0.791 |
| n_p | 1.923 | 1.923 | 1.785 | 1.785 | 1.785 |
| f/f1 | 0.454 | 0.454 | 0.727 | 0.455 | 0.455 |
| f/f2 | 0.829 | 0.804 | 0.855 | 0.782 | 1.035 |
| fG1/fG2 | −0.359 | −0.334 | −0.137 | −0.068 | −0.493 |
| (RG1_S1 − RG1_S2)/ | −0.117 | −0.117 | −0.240 | −0.117 | −0.117 |
| (RG1_S1 + RG1_S2) | | | | | |
| D11P/DR | 1.048 | 1.045 | 1.126 | 1.042 | 1.040 |
| D12P/DR | 0.476 | 0.475 | 0.512 | 0.474 | 0.473 |
| f/fG2 | −0.408 | −0.375 | −0.191 | −0.076 | −0.647 |
| DP22/DR | 1.952 | 1.698 | 1.752 | 1.696 | 1.694 |
| RG2_S1/fG2 | −0.103 | −0.091 | −0.04 | −0.016 | −0.150 |
| fG1/L | 0.647 | 0.613 | 0.506 | 0.610 | 0.538 |
| Lf/Lr | 0.204 | 0.188 | 0.184 | 0.183 | 0.194 |
| D12P/L | 0.038 | 0.036 | 0.036 | 0.035 | 0.036 |
| D23/L | 0.019 | 0.036 | 0.080 | 0.080 | 0.079 |
| D3/L | 0.545 | 0.487 | 0.454 | 0.455 | 0.434 |
| Fno*(fG1/f) | 2.994 | 2.941 | 2.507 | 2.993 | 2.518 |

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical imaging system, comprising:
a first lens group comprising a first lens, a reflective member, and a second lens arranged in order from an object side to an imaging side; and
a second lens group, disposed behind the second lens, and comprising a plurality of lenses,
wherein the first lens has positive refractive power, and has a convex object-side surface and a concave image-side surface, and
wherein the first lens is spaced apart from the reflective member, and the second lens is bonded to the reflective member.

2. The optical imaging system according to claim 1, wherein the reflective member is configured to rotate based on two axes, perpendicular to each other.

3. The optical imaging system according to claim 2, wherein one of the two axes is one of an optical axis of the first lens or an axis, parallel to the optical axis of the first lens.

4. The optical imaging system according to claim 1, wherein the reflective member comprises an incident surface, a reflection surface, and an exit surface, and
wherein an effective diameter of the object-side surface of the first lens is greater than a minor axis length of the incident surface of the reflective member.

5. The optical imaging system according to claim 1, wherein the reflective member comprises an incident surface, a reflection surface, and an exit surface, and
wherein 0.9<D11P/DP22<1.5 is satisfied, where D11P is a distance from the object-side surface of the first lens to the reflection surface of the reflective member, and DP22 is a distance from the reflection surface of the reflective member to an image-side surface of the second lens.

6. The optical imaging system according to claim 1, wherein 0.5<|RG1_S1/RG1_S2|<1.2 is satisfied, where RG1_S1 is a radius of curvature of the object-side surface of the first lens, and RG1_S2 is a radius of curvature of the image-side surface of the first lens.

7. The optical imaging system according to claim 1, wherein 1.7<n_p<2.0 is satisfied, where n_p is a refractive index of the reflective member.

8. The optical imaging system according to claim 1, wherein −0.7<fG1/fG2<0 is satisfied, where fG1 is a total focal length of the first lens group, and fG2 is a total focal length of the second lens group.

9. The optical imaging system according to claim 1, wherein 0.4<f/f1<0.75 is satisfied, where f is a total focal length of the optical imaging system, and f1 is a focal length of the first lens.

10. The optical imaging system according to claim 1, wherein 0.1<f/f2<1.1 is satisfied, where f is a total focal length of the optical imaging system, and f2 is a focal length of the second lens.

11. The optical imaging system according to claim 1, wherein −0.35<(RG1_S1−RG1_S2)/(RG1_S1+RG1_S2)<0 is satisfied, where RG1_S1 is a radius of curvature of the object-side surface of the first lens, and RG1_S2 is a radius of curvature of the image-side surface of the first lens.

12. The optical imaging system according to claim 1, wherein the reflective member comprises an incident surface, a reflection surface, and an exit surface, and
1<D11P/DR<1.3 is satisfied, where D11P is a distance from the object-side surface of the first lens to the reflection surface of the reflective member, and DR is the distance from the incident surface of the reflective member to the reflection surface of the reflective member.

13. The optical imaging system according to claim 1, wherein 0.4<D12P/DR<0.6 is satisfied, where D12P is a distance from the image-side surface of the first lens to the incident surface of the reflective member, and DR is a distance from the incident surface of the reflective member to the reflection surface of the reflective member.

14. The optical imaging system according to claim 1, wherein the second lens has positive refractive power, and has a convex image-side surface.

15. The optical imaging system according to claim 1, wherein at least three lenses of the lenses of the second lens group have a refractive index greater than 1.6.

16. An optical imaging system, comprising:
a reflective member;
a first lens, having positive refractive power, and disposed in front of an incident surface of the reflective member; and
a second lens, bonded to an exit surface of the reflective member, and configured to rotate with the reflective member,
wherein the first lens is spaced apart from the reflective member.

17. The optical imaging system of claim 16, wherein the optical imaging system comprises a total of seven lenses.

18. The optical imaging system of claim 16, wherein the first lens has a convex object-side surface and a concave image-side surface.

19. The optical imaging system of claim 16, wherein the second lens has a flat object-side surface.
